(19) United States
(12) Patent Application Publication
(10) Pub. No.: US 2003/0040949 A1
(43) Pub. Date: Feb. 27, 2003

(54) Method and system for developing and providing effective training courses

(76) Inventors: Paul Baccaro, Rochester, NY (US); Larry Conrow, Rochester, NY (US); Lesley Darling, Macedon, NY (US); Graham Diehl, Rochester, NY (US); Terri Renner, Rochester, NY (US); Mark Martin, Rochester, NY (US); Matthew Smith, Rochester, NY (US); Jeff Felice, Shortsville, NY (US)

Correspondence Address: John Campa, Esq., NIXON PEABODY LLP, Clinton Square, P.O. Box 31051, Rochester, NY, 14603-1051, US

(21) Appl. No.: 10/215,433

(22) Filed: Aug. 7, 2002

Related U.S. Application Data
(60) Provisional application No. 60/310,649, filed on Aug. 7, 2001.

(51) Int. Cl. G06F 17/60

(52) U.S. Cl. 705/7; 705/1

(57) ABSTRACT

A method and system for developing effective training content. The system provides training content that observes a learning-centered principal, a results-oriented principal and an engagement principal. One or more course development phases are performed which ensure that the principals are observed. The development phases include a needs analysis phase, a project kickoff phase, an outlining phase, a training course design phase, a design analysis phase, an activity development phase, an activity analysis phase, a production scheduling phase, a storyboard development phase, a content development completion phase, a storyboard completion phase, review-edit phases, a keytest phase, and a training course assembly phase. Further, the training content is delivered via the Internet, an Intranet, in a computer-readable medium or in printed form.

This application claims the benefit of U.S. Provisional Patent Application Ser. No. 60/310,649 filed on Aug. 7, 2001, which is hereby incorporated by reference in its entirety.

### FIELD OF THE INVENTION

This invention relates generally to methods for creating training materials and, more particularly, to a method and system for producing effective training materials by adhering to one or more principals of effective learning during the training material development, such as a learner-centered, resultsoriented and engagement principal.

### BACKGROUND OF THE INVENTION

Studies have been conducted towards making training materials more effective. To be effective, training materials should be engaging to a student regardless of the medium they are provided on, such as in printed form or presented visually on a computer display, for example. Current processes for developing training materials are often haphazard and do not adhere to any particular format, organization or style intended to maximize the ability of a student to learn and retain the information and lessons attempted to be conveyed. Heretofore, a structured approach for developing and providing effective training materials has not been defined. Moreover, procedures have not been established that may be performed repeatedly by organizations to consistently create effective training materials that engage students and maximize learning.

### SUMMARY OF THE INVENTION

A system for developing effective training materials in accordance with one embodiment of the present invention includes a training course development system that develops a training course, and a compliance system that ensures the developed training course observes at least one of a learning-centered principal, a results-oriented principal and an engagement principal.

A method and a program storage device readable by a machine and tangibly embodying a program of instructions executable by the machine for developing effective training materials in accordance with embodiments of the present invention includes developing a training course, and ensuring that the developed training course observes at least one of a learning-centered principal, a results-oriented principal and an engagement principal.

The present invention provides a method which when followed results in producing highly effective training materials that facilitate learning. The method provides a consistent approach that is flexible enough to be implemented by a variety of diverse organizations, such as auto manufacturers or universities, for producing the effective training materials for a variety of training purposes, such as for providing basic, moderate or advanced levels of training. The present invention is easy and inexpensive to implement yet increases the quality and consistency of the training materials produced over that of existing processes.

### BRIEF DESCRIPTION OF THE DRAWINGS

FIG. 1 is a flowchart of a process for developing effective training materials in accordance with one embodiment of the present invention;

FIG. 2 is a functional block diagram of a system for developing effective training materials in accordance with another embodiment of the present invention;

FIG. 3 is a diagram of a course level structure enforced by a design type definition in accordance with another embodiment of the present invention;

FIG. 4 is a diagram of a topic level structure in the course level structure shown in FIG. 3;

FIGS. 5-16 are screen shots of the training materials developed in accordance with an embodiment of the present invention; and

FIGS. 17-21 are printouts of the training materials developed in accordance with an embodiment of the present invention.

### DETAILED DESCRIPTION OF THE INVENTION

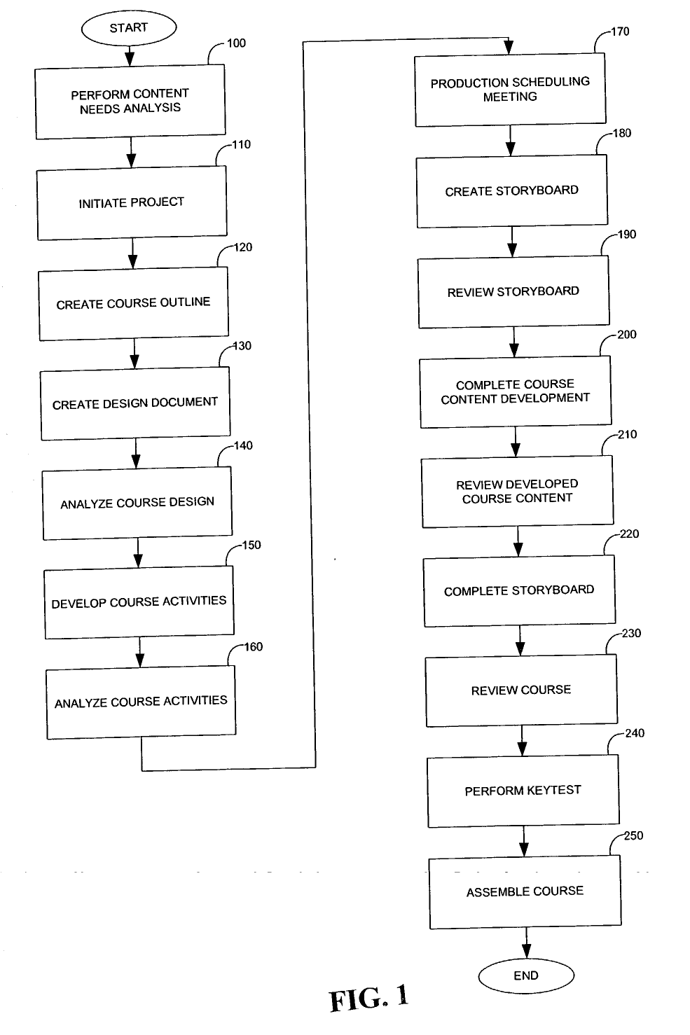

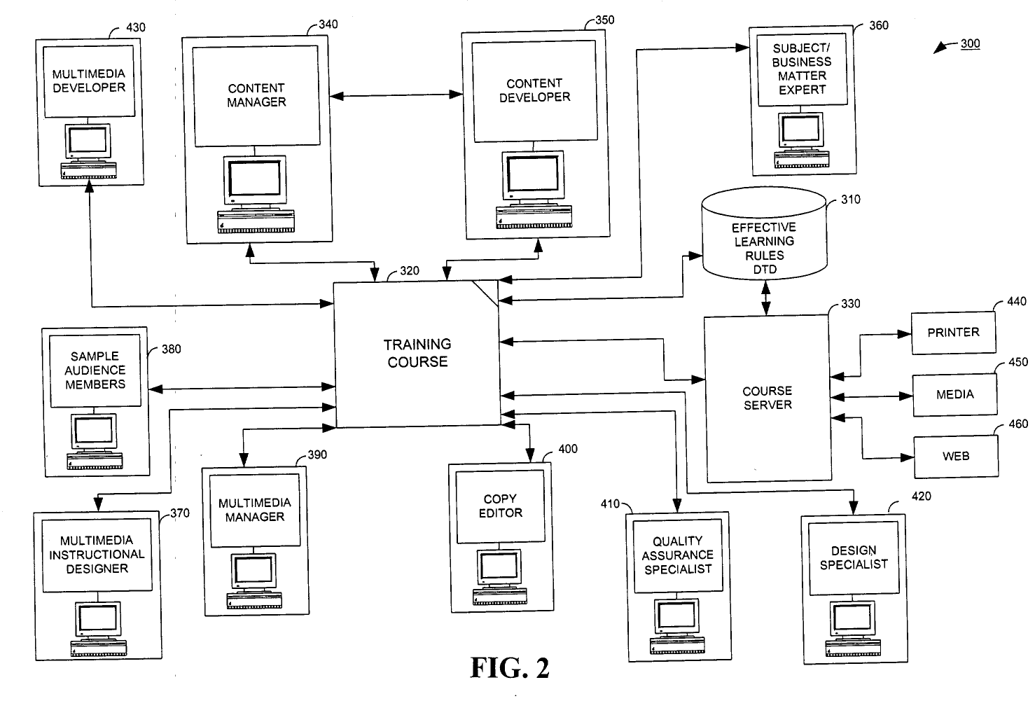

A method and system 300 for developing effective training materials in accordance with one embodiment of the present invention is shown in FIGS. 1-2. In this particular embodiment, a design type definition (“DTD”) 310 is used to develop a training course 320 that exhibits at least one of three principles of effective learning, including a learning-centered principal, a results-oriented principal and an engagement principal. Further, one or more course developers, such as a content manager 340 or a content developer 350, each having defined responsibilities, participate in developing the training materials at one or more defined phases, such as steps 100-250, to ensure that the training materials comply with one or more of the principals of effective learning, as well as other criteria, as described further herein below. The present invention provides a method that enables producing highly effective training materials that facilitate and enhance learning, regardless of the audience intended to consume the resulting materials. The method can be implemented by a variety of diverse organizations for a variety of training purposes. Moreover, the method is easy and inexpensive to implement.

The operation of the system 300 for developing effective training materials in accordance with an embodiment of the present invention will now be described with reference to FIGS. 1-4. The present invention has realized that there are several principles of effective training, which when observed, singly or in combination, result in an effective teaching method. These principals include the premise that instructional content should include overt learning activities and be learner-centered, results-oriented and engaging. Navigation and reading are not overt learning activities.

The learner-centered principal means that users need to have a choice of what and how they learn, and that users need to be actively involved in the learning process. Learner-centered instructional content guidelines include: giving opportunities for meaningful guided and unguided activity and practice during a training session; giving opportunities to users to participate in active demonstrations and practice activities; varying the level of complexity and support as the course progresses; giving the users opportunities to solve problems on their own instead of giving them the solution using questioning and activities to help the user become activated by the content; guiding discussions by asking openended questions that focus users on how the content relates to them and their environment; developing activities that provide proof of value or relationship to the user; giving users the opportunity to be active versus passive; ensuring that about sixty percent of the training time is spent in overt user activities that relate to content; and avoiding long lectures without any activity, practice or discussion.

Guided activities give users very specific instruction, including support or scaffolding. Unguided activity provides more general instruction, with less support. The level of guided and unguided activity is dependent on the experience of the user. The instructional content of the present invention gives the user a unique experience using a combination of unguided and guided activity at the level appropriate for the individual user.

The results oriented principle will now be described. Instructional content that does not support learning towards a result has decreased instructional value. One or more portions of the method in this embodiment, such as steps 100250, ensures that the instructional content consistently follows the results-oriented principle. The instructional content of the present invention is developed and arranged such that a user can transfer and retain what they have learned, and ensures that what they have learned is based on job-context. The guidelines that support the results-oriented principle include designing content to be performance outcome-based; naming the majority of topics to reflect performance outcomes; organizing content based on how one would use the technology and not on information about the technology; organizing content according to user needs and performance outcomes; breaking training into manageable pieces; sequencing pieces logically and watching for missing pieces; placing activities appropriately; supporting performance outcomes with knowledge needed information and present/re-affirm this information as close as possible to the performance outcome; being accountable for developing content that helps users meet objectives; developing and stating clear learning objectives; developing training content to support the learning objectives; matching assessment and activities to the learning objectives; developing content to support the learning objectives; designing the delivery media to support the instructional methods; basing the media used supports and the delivery of information on the objective and instructional methods; designing for activity and practice with a high level of fidelity; and using media to support attention and memory so as to not distract users by avoiding force-fitting content into the delivery media.

The engagement principle will now be described. Training content should motivate users to learn. Regardless of whether the training content is provided in electronic or hard-copy form, the method and system 300 in this embodiment ensures that the user is motivated or engaged in the learning process. Users should be motivated to learn. Engaging the user means drawing them into the training content. These guidelines include focusing and maintaining the user's attention; maintaining variety in design and delivery; focusing a users attention on what they need to learn by avoiding complex visuals, too much text, or superfluous media; ensuring frequent practice and meaningful activity; filtering nice-to-know information from need-to-know information; establishing relevance early and often; establishing incentives for each performance outcome; making users as active as possible in determining the value to them; using reflective questions to enable the users to reflect back on their own experience; building the user's confidence; organizing training sessions from simple to complex; providing encouraging feedback and support; giving the users a safe place to practice; giving a user early successes with an appropriate level of support; giving a user opportunities for satisfaction; giving the user opportunities for challenge once confidence is established; piquing a user's curiosity; and using increasingly complex examples along with unguided practice.

Further, the design and development of instructional content is part art and part science. Instructional content can not be haphazardly prepared with the hope that users will learn from it effectively. A consistent and systematic approach to designing and developing content can produce instructional content that guarantees users the opportunity to gain skills and knowledge they can apply and integrate. This approach also takes into consideration the need to develop content for a wide audience, the notion that the development of consistent instruction in both multimedia and live delivery provides a blended solution and saves time and cost.

Thus, by way of example only, an organization, such as a course developing business entity, may desire determining a market to develop training materials for. Thus, referring to FIGS. 1-2 and beginning at step 100, a product planning team may perform a content needs analysis to determine an overall mission of a training course 320, to determine characteristics of the training course audience, and to gather any additional information that may impact the development of the training course 320. For instance, this content needs analysis may be performed to determine which types of courses the current market might support for a particular subject, such as for a particular computer software application, for example.

In this embodiment, the content manager 340 is responsible for ensuring the quality and consistency of the content developed by members of their group, facilitating the content outline event, analyzing the design document based on the principles of effective instruction criteria and evaluating all course components to make sure the principles of instructional effectiveness are met based on one or more criteria.

The content developer 350 is responsible for creating a design document from content outline event information, developing all instructional components based on criteria, presenting the activities to test the flow of the course, working with the multimedia instructional designer 370 to ensure consistency between self-study and instructor-led content, and gaining technical knowledge throughout the design and development process.

The multimedia instructional designer 370 is responsible for translating between off-line and online content, attending the activity analysis event, documenting areas where multimedia content needs to differ from instructor-led content, and storyboarding content so that the multimedia developer 430 can effectively produce each element.

The multimedia manager 390 is responsible for ensuring the quality and consistency of the multimedia products and maintaining an efficient and effective production process.

The multimedia developer 430 is responsible for producing multimedia components based on detailed storyboards, using an organization's specific standards, tools, and technologies, and assembling, testing, and posting multimedia content.

The subjectibusiness-matter expert (“SME/BME”)360 is responsible for adding real-world experience and subject-matter expertise, answering technical and context questions during development and reviewing developed content for technical accuracy.

The copy editor 400 is responsible for ensuring that content conforms to style guidelines and grammatical standards.

The quality assurance specialist 410 is responsible for checking final output for completeness, checking to ensure steps in activities key correctly and checking for formatting issues.

In this particular embodiment, one or more course developers in the system 300, such as the content manager 340 or the content developer 350, for example, have access to and can operate a conventional personal computer with a CPU, memory, display device and an I/O unit for accessing the training course 320, as described further herein in connection with steps 100-250 and shown in FIG. 2, although the present invention may be implemented in other manners. The lines in FIG. 2 connecting one or more blocks are intended to show communication flow, and not physical connections. In this particular embodiment, the personal computers utilized by the course developers in the system 300 are coupled together by one or more buses to enable the course developers to communicate and collaborate with each other, as described further herein.

Furthermore, the computers may be coupled to a course server 330. The course server 330 may comprise a conventional server machine with a CPU, memory, and an I/O unit for connecting the server 330 to the computers. The course server 330 may be operating one or more conventional project management or collaboration software applications to enable one or more of the system 300 course developers to access the training course 320 during performance of steps 100-250, as described herein. Furthermore, the course server 330 may be connected to the computers by one or more networks, including Intranets or the Internet, for example.

In embodiments of the present invention, the course server 330 stores in a memory a design type definition (“DTD”) 310, which enforces one or more of the above-described effective learning guidelines as a set of rules, as described further herein below. In general, a design type definition is a formal description in XML Declaration Syntax of a particular type of document. In this embodiment, the DTD 310 defines how the data in an XML based document, such as the training course 320, should be structured, although other document format types may be used. For instance, the DTD 310 may specify which names may be used to describe different types of elements, such as a document title or content type in training course 320, for example. Moreover, the DTD 310 defines how the training content within the training course 320 should be organized

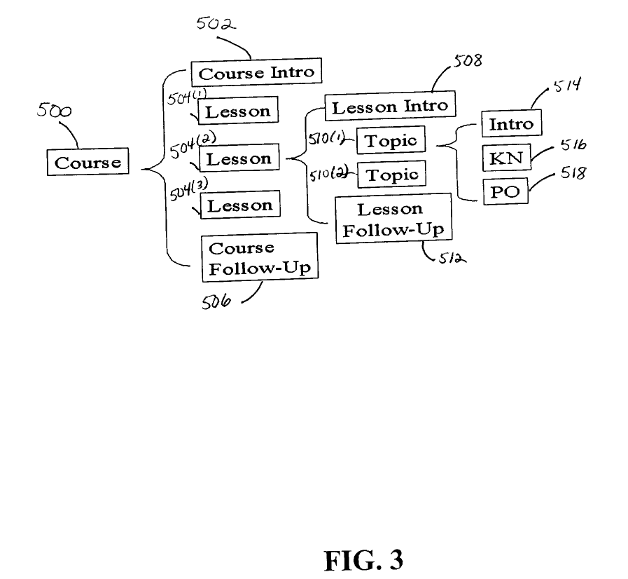

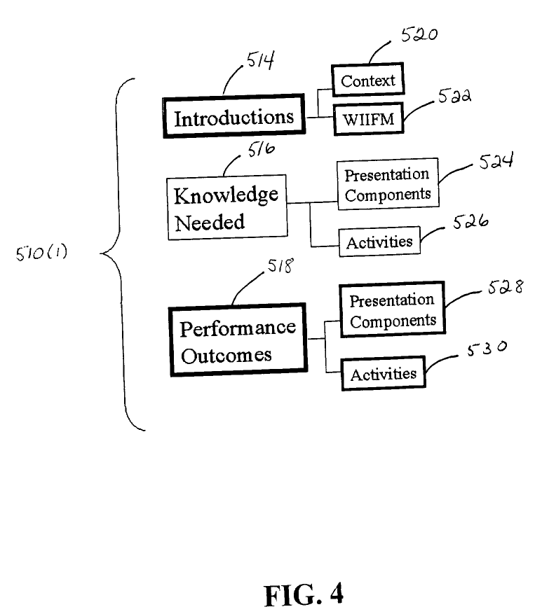

Referring to FIGS. 3-4, the DTD 310 includes syntax that enables training content data to be included in the training course 320 in the manner shown in FIG. 3. Thus, in this embodiment, the DTD 310 causes course data 500, course intro data 502, lesson data 504(1)-504(3) and course follow-up data 506 within the training course 320 to be organized in the manner shown in FIG. 3. Moreover, each one of the lesson data 504(1)-504(3) include lesson intro data 508, topic data 510(1)-510(2), and lesson follow-up data 512. Moreover, each of the topic data 510(1)-510(2) include topic intro data 514, knowledge needed data 516, and performance outcome data 518. Referring to FIG. 4, the topic intro data 514 includes context data 520 and “what's in it for me” information 522. The knowledge needed data 516 includes knowledge needed presentation component data 524 and knowledge needed activity data 526. Still further, the performance outcome data 518 includes performance outcome presentation component data 528 and performance outcome activity data 530. Thus, the syntax included in the DTD 310 cause the data within the training course 320 to be organized in the manner shown and described above in connection with FIGS. 3-4. Further, this structure, as illustrated in FIGS. 3-4, was selected to ensure that data organized in this manner satisfies one or more of the effective learning guidelines mentioned above, such as the learning-centered principal, the results-oriented principal and the engagement principal. Moreover, the DTD 310 ensures that existing SCORM, AICC, and IMS standards are complied with. Additionally, the DTD 310 utilizes Dr. Ruth Clark's Content-Performance Matrix, which is an implementation of Merill's Components Display Theory, and also utilizes Horn's Information Mapping Technology, all of which are hereby incorporated by reference in their entirety, in addition to research results obtained by the present inventors.

In this embodiment, the training course 320 comprises an XML based document that is stored in a memory of the course server 330, although other document formats may be used. Further in this embodiment, the training course 320 is linked with the DTD 310. One or more course developers in the system 300 may operate on their respective computer an editor program capable of accessing, viewing and editing XML based documents, such as Dreamweaver, for example. Thus, when a course developer accesses the training course 320, they may edit the training course for inputting data into the course 320 document only as permitted by the rules set forth in the DTD 310, as described above.

Next at step 110, the content manager 340 and the content developer 350 collaborate to initiate a project for developing a training course 320. Here, the resources that are needed to design a course 320 are determined, such as whether a subject/business matter expert 360 (“S/BME”) external to the entity developing the training course 320 is needed, or if an internal S/BME 360 will suffice for completing one or more of the course development phases described herein in connection with steps 100-250. The S/BME 360 is utilized to provide an additional resource for preparing the training course.

Next at step 120, the content manager 340, the content developer 350 and the S/BME 360 collaborate to prepare an outline for the course 320 and to determine the type of content the training course 320 should cover. Further, a first draft of the training course 320 is prepared.

Next at step 130, the content developer 350 creates a detailed training course 320 design document. The training course 320 design document is used for guiding remaining course development phases.

Next at step 140, the content manager 340 and the content developer 350 evaluate the training course 320, created above at step 130, to ensure that the training course 320 satisfies the results-oriented principle, as described above.

Next at step 150, the content developer 350 develops lesson introductions, such as lesson introduction data 508 in FIG. 3, and lesson activities for levels of the training course 320.

Next at step 160, content manager 340, content developer 350, multimedia instructional designer 370, and the content manager 340 determine whether the lesson introductions and the lesson activities developed above at step 150 exhibit the three principles of effective learning described above, such as the learning-centered principal, the results-oriented principal and the engagement principal.

Next at step 170, content manager 340, content developer 350, multimedia manager 390, copy editor 400, quality assurance specialist 410 and design specialist 420 determine an amount of the training course 320 to deliver per batch, and to create a schedule for post batch delivery activities. This step is performed to enable one or more course developers, such as the content manager 340 and the content developer 350, to work on the training course 320 in parallel where the course 320 is unusually lengthy and can be separated into one or more portions or batches.

Next at step 180, multimedia instructional designer 370 creates a storyboard and documentation for modifying the training course 320 to be presented on multimedia.

Next at step 190, the content manager 340 and the multimedia instructional designer 370 review the storyboard created above at step 180 to ensure that the guidelines for effective learning are being observed.

Next at step 200, content developer 350 revises the training course 320 based upon a determination at step 160 that at least one of the principles of effective learning are not exhibited by the training course 320. The course 320 is revised until it is determined that the training course 320 observes the three principles of effective learning. Additionally, one or more of the training course 320 batches, determined above at step 170, are prepared for delivery.

Next at step 210, the completed training course 320 content is reviewed by the content manager 340 and/or the S/BME 360.

Next at step 220, the multimedia instructional designer 370 completes the storyboard by adding all other elements to the storyboard. The storyboard and the documentation created above at step 180 are incorporated into the training course 320.

Next at step 230, the content manager 340 and the S/BME 360 review and edit the training course 320 until it is determined that the course 320 observes the principles of effective learning, is technically accurate, and is grammatically and stylistically correct.

Next at step 240, the quality assurance specialist 410 performs a keytest on the training course 320 to compare the accuracy of documented keystrokes and results against actual keystrokes and results, and to perform a proof of print output using the printer 440, for example.

Next at step 250, the multimedia developer 430 formats the training course 320 upon determining above at step 240 that the actual keystrokes and results are accurate for presentation on a multimedia medium, such as media 450 or for delivery to a client machines on the Web 240. Although one or more course developers, such as content developer 350, have been identified as performing one or more of steps 100-250, the present invention contemplates that different course developers may perform the same steps.

An alternate embodiment of system 300 will now be described. In this embodiment, steps 100-250 are performed by a computing device, such as course server 350. Further, the steps described above in connection with steps 100-250 are stored on a computer-readable medium that may be read and executed by a processor of the server 350. The computer-readable medium comprises a hard-disk, although a portable data storage medium may be used, such as a floppydisk, compact-disc, digital-video disc, magnetic tape or optical disk.

Another alternate embodiment of system 300 will now be described. In this embodiment, steps 100-250 are performed as described above, except the course server 330 stores the training course 320 in media 450, which may comprise a computer-readable medium, such as a hard-disk, although a portable data storage medium may be used, such as a floppy-disk, compact-disc, digital-video disc, magnetic tape or optical disk.

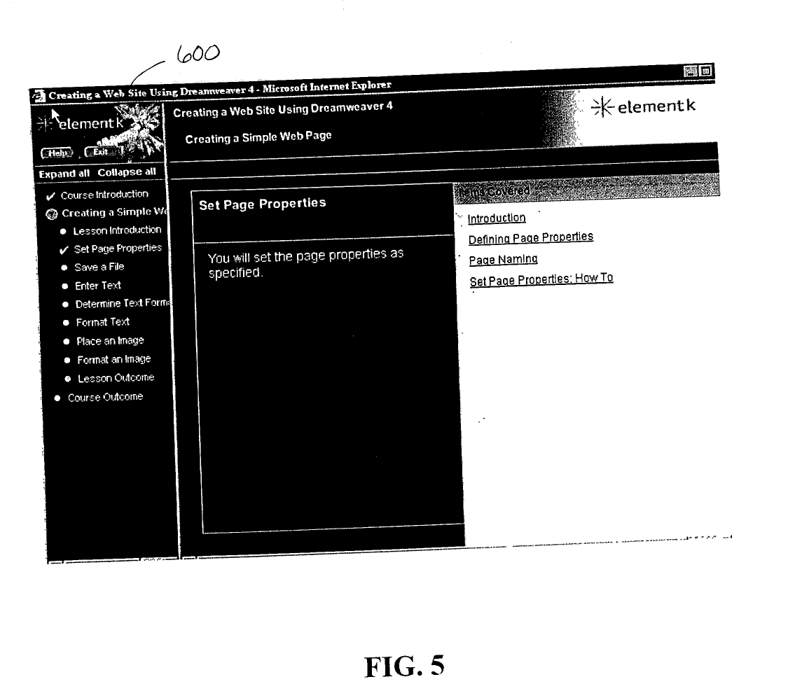

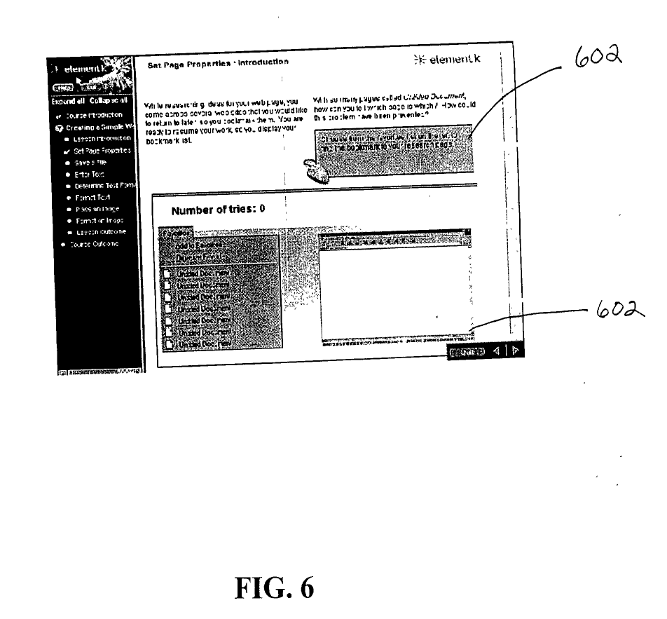

Another alternate embodiment of system 300 will now be described with reference to FIGS. 5-16. In this embodiment, steps 100-250 are performed as described above, except the course server 350 delivers the training course 320 to one or more computers having access to the Web 460. Referring generally to FIGS. 6-17, one of the computers on the Web 460 are able to display the training course 320 developed above at steps 100-250.

In this embodiment, the course server 330 uses Macromedia Director output to Shockwave files, combined with XML, for delivering the training course 320 over the Web 460. The Shockwave Player is one of the several Web-based streaming technologies that may be used to effectively deliver a truly engaging and interactive learning experience. The present invention may also utilize Macromedia Flash, Dreamweaver, Adobe and Photoshop, for example, to deliver the training content. In addition, the present invention supports the SCORM and IMS specifications, including Microsoft's implementation of IMS using LRN viewer and the AICC standard.

Referring to FIG. 5, a left navigation 600 and content pane showing topic structure is illustrated. The lesson and topics are accessible while viewing the content to support user confidence (giving them context) and to also allow users choices.

Referring to FIG. 6, an introduction screen showing activity is illustrated. The present invention ensures that all content consistently establishes context and relevance (“WIIFM” or “what's in it for me”), and also allows the user the opportunity of “proof” through activity. This supports the user-centered principle (i.e., user activity) as well as the engagement principle (i.e., relevance and confidence).

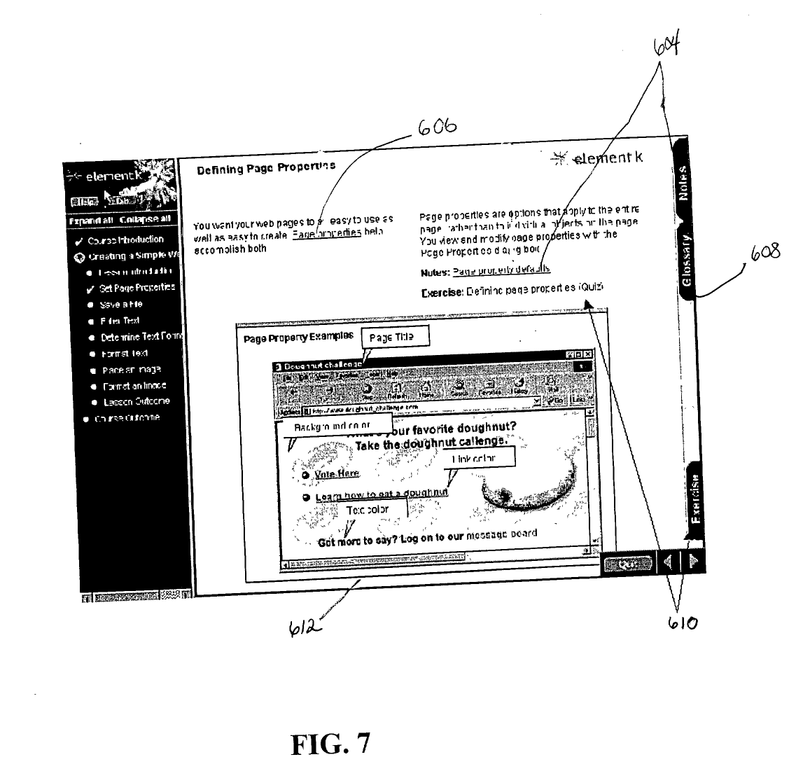

Referring to FIG. 7, a knowledge needed screen showing links and tabs is illustrated. Users need to focus attention on what they need to know in order to accomplish a task. The present invention separates need to know from nice to know information through the use of links and tabs. The need to know information is the focus, the nice to know and reference information is available by clicking on the related link, and the associated tab will be displayed with the detail. This supports appropriate filtering of information for users. Instructional information is developed and presented based on the guidelines and criteria of the present invention as described herein.

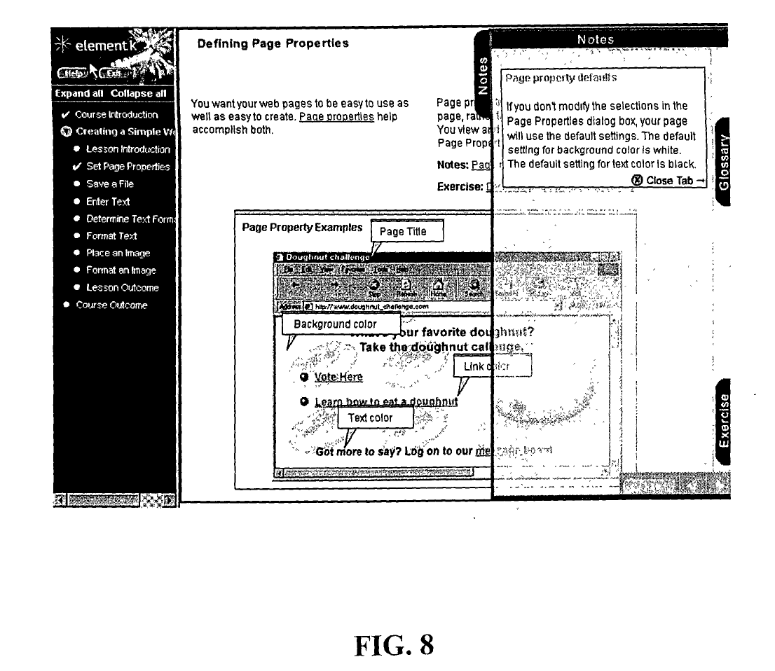

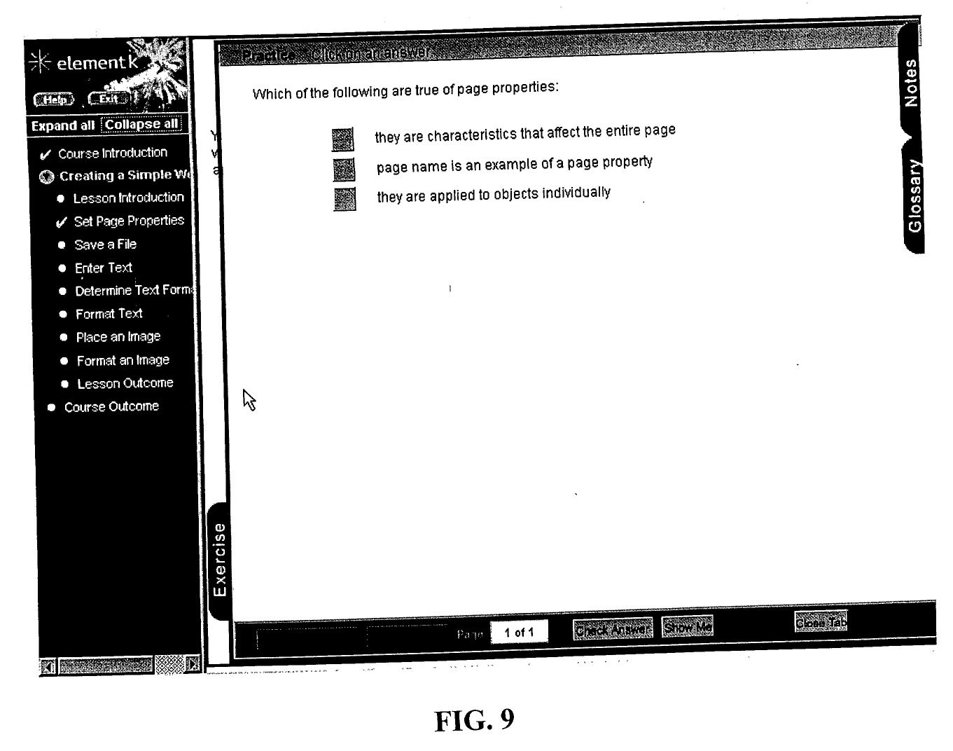

Referring to FIG. 8-9, a nice to know (Notes) tab being extended and an exercise tab extended are illustrated. Activities are determined and designed based on guidelines discussed herein. At least one type of activity/exercise that allows users to check their knowledge before moving on or to give additional rehearsal of critical knowledge is the inline quiz. This supports user confidence as well as retention. Users can choose to access the exercise either by clicking on the link or the tab. User choice is supported since the exercise is optional.

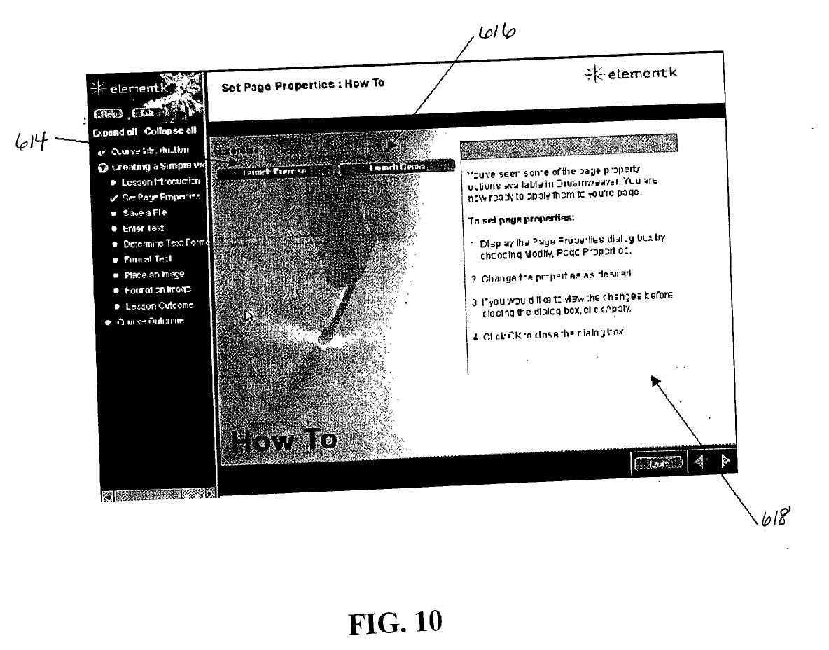

Referring to FIG. 10, a performance outcome screen with presentation components (general procedure steps) and launch buttons for demo and exercise are illustrated. The performance outcome in this case is a procedure content type, so the general procedure steps are displayed for the user's reference. The user has the choice of seeing a demonstration, which can be either a simulation of the application, image, animation or video depending on the content, and/or participating in an activity.

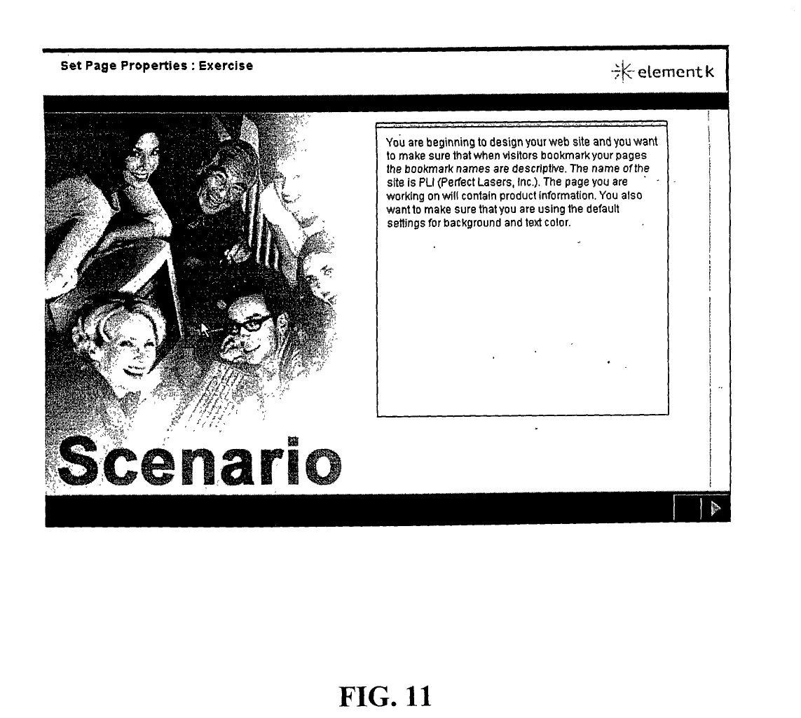

Referring to FIG. 11, a first screen of practice activity is illustrated. Scenarios build relevance and real world examples into the user's experience. Scenarios support user satisfaction and the transfer of knowledge.

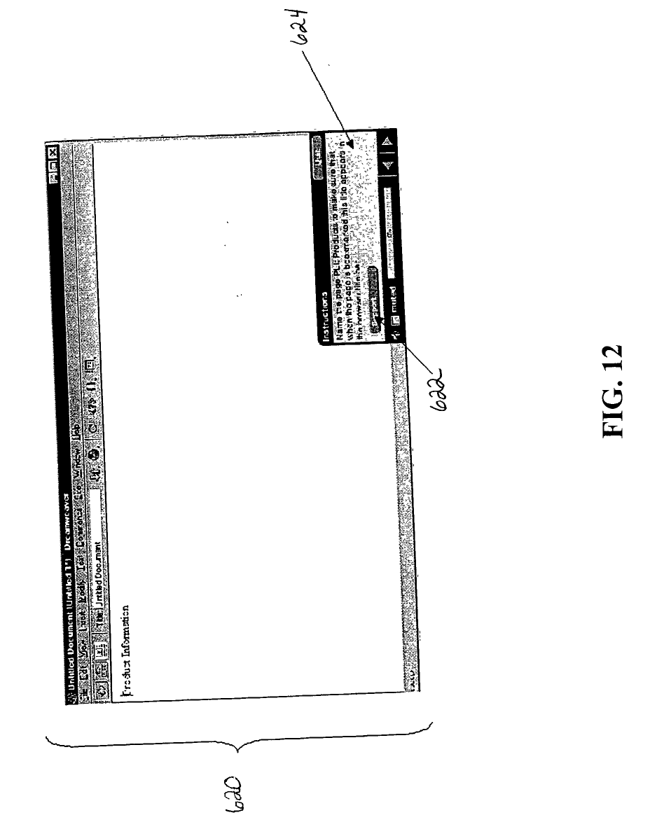

Referring to FIG. 12, an activity with simulation having an unguided step is illustrated. A high-fidelity simulation of the application with hands-on activity steps appropriate to the user gives the user an appropriate level of confidence and satisfaction. The user can either try the step in the simulation and move to the next step it is correct, get feedback and support if it is incorrect, or get support (i.e., guided steps) before they try. User choice, confidence and satisfaction are applied as well as the ability to transfer learning.

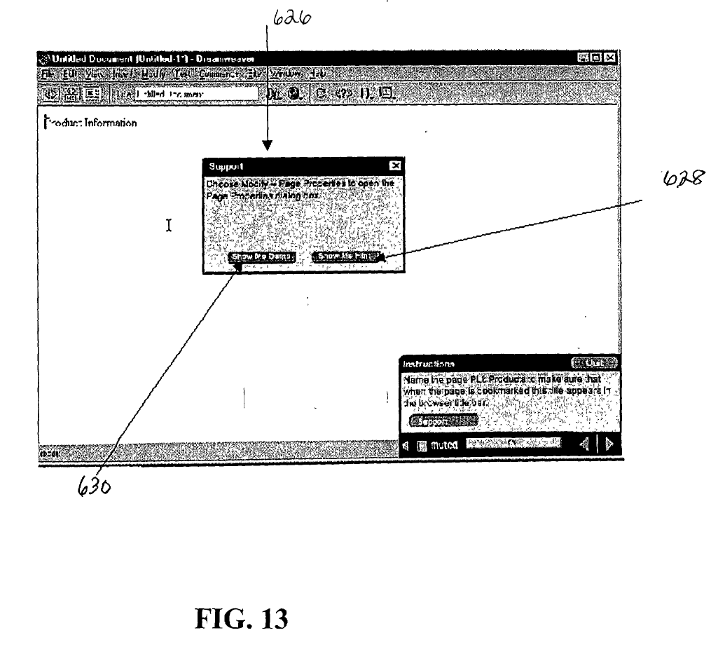

Referring to FIG. 13, a simulation with a first level of support is illustrated. In this example, a user either asked for support before trying the hands-on step by pressing the support button, or the user performed an incorrect action when attempting the step and received feedback in addition to the guided step. If the user needs additional support from this level, they can choose to view a hint or they can see a demonstration of the step.

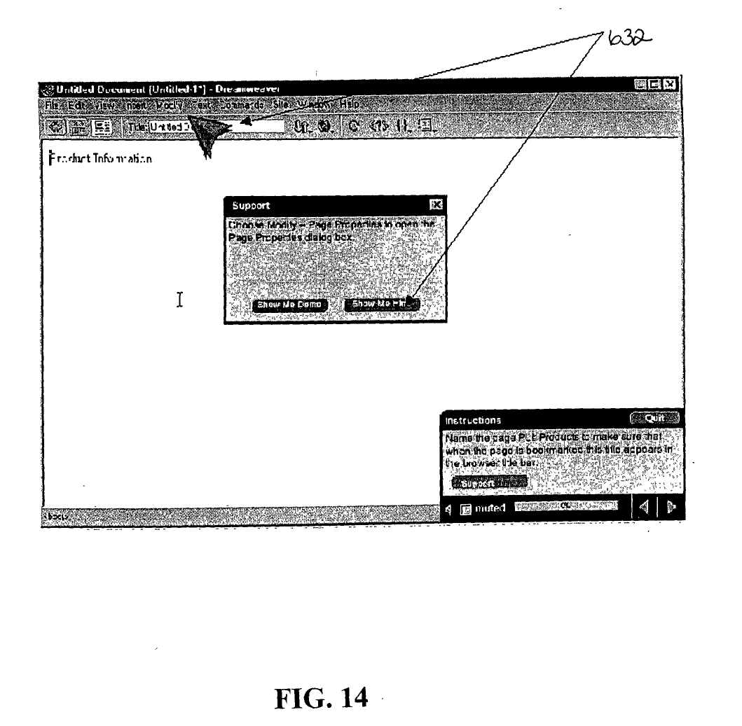

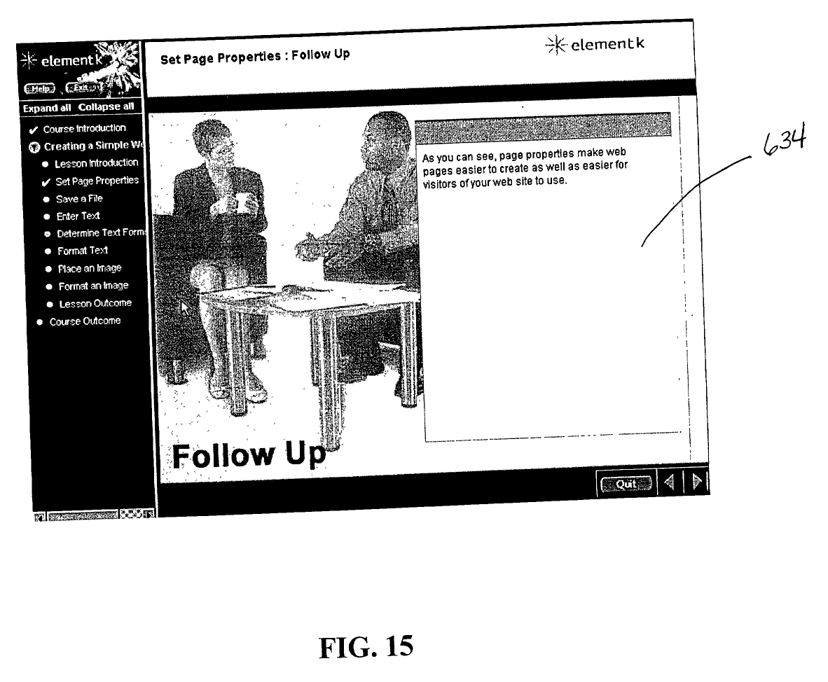

Referring to FIGS. 14-15, screen shots showing a simulation with a hint and a follow-up screen is illustrated, which gives context and completion to user. The follow-up may include reflective questions and activities that support and reinforce the objective.

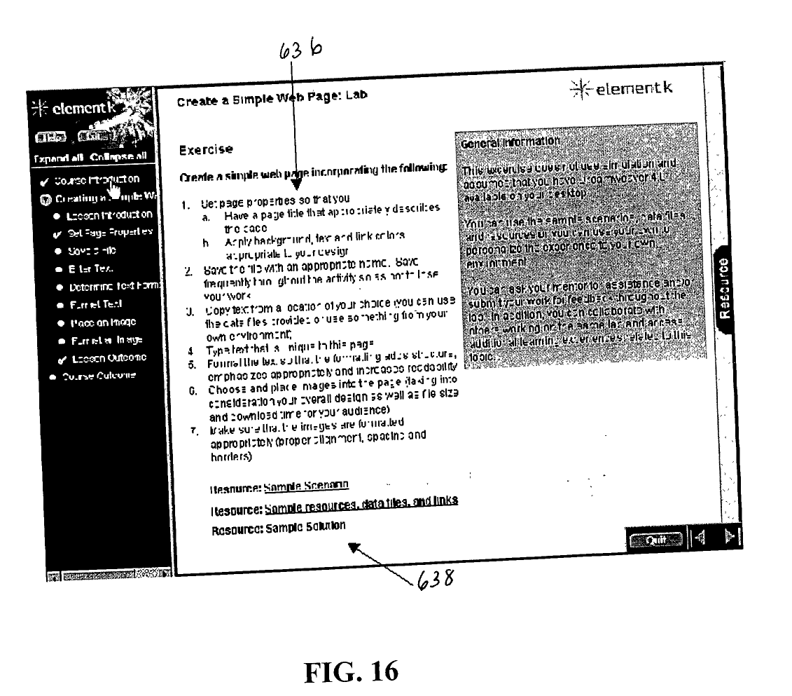

Referring to FIG. 16, a lesson level lab (non-simulated) is illustrated. The lesson-level lab takes the user to the application and integration level of learning where they are not working in a simulated environment, and are integrating all the skills within the lesson. A sample scenario is shown as well as tools and information resources necessary to complete the lab. A sample solution is given so that the users can check their work. This allows users to either start with the lab and use the topic level information to support them (i.e., cognitive apprenticeship), or use the lab as a follow-up integration activity if the course is taken in a linear fashion. The present invention supports transfer, application and integration as well as the user-centered principle.

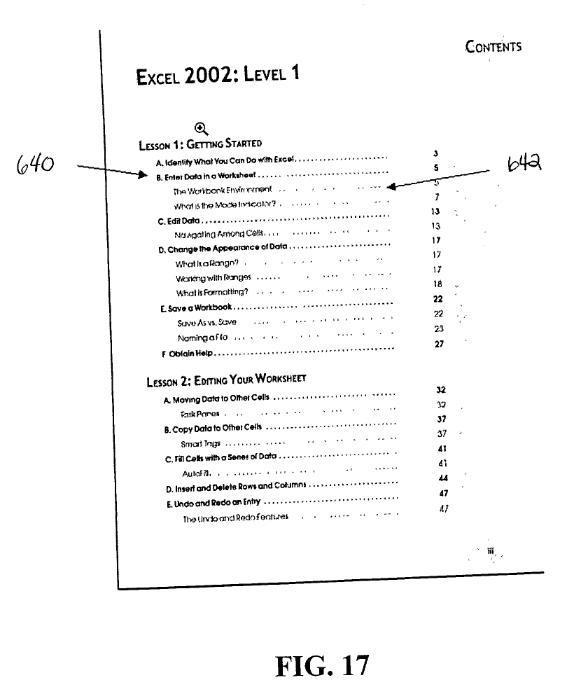

Another alternate embodiment of system 300 will now be described with reference to FIGS. 17-21. In this embodiment, steps 100-250 are performed as described above, except the course server 330 sends the training course 320 to printer 440. Referring to FIG. 17, a print output of a table of contents is illustrated. The lesson and topics are easily called out in the table of contents. The supporting content is directly associated with the topics, which are based on performance outcomes. In this embodiment, the printed content comprises a student manual and an associated instructor manual for the delivery of instructor-facilitated training. Moreover, the graphic design and content selection is based upon the principles of effective instruction and instructor and user feedback.

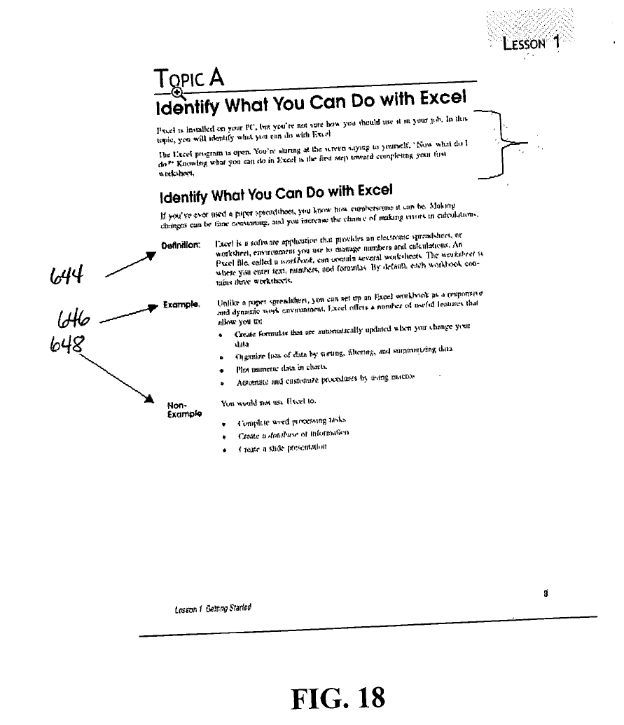

Referring to FIG. 18, a topic introduction and presentation components are illustrated. The present invention ensures that all content consistently establishes context and relevance (i.e., WIIFM) in the introduction of each topic. This supports the user-centered principle (i.e., user activity) as well as the engagement principle (i.e., relevance and confidence). All instructional information is developed and presented based on the guidelines and criteria described herein. This example shows the required instructional components based on an implementation of a content-performance matrix. The components are used in the DTD, described above, and are consistently developed. The presentation is best used in teaching and for reference.

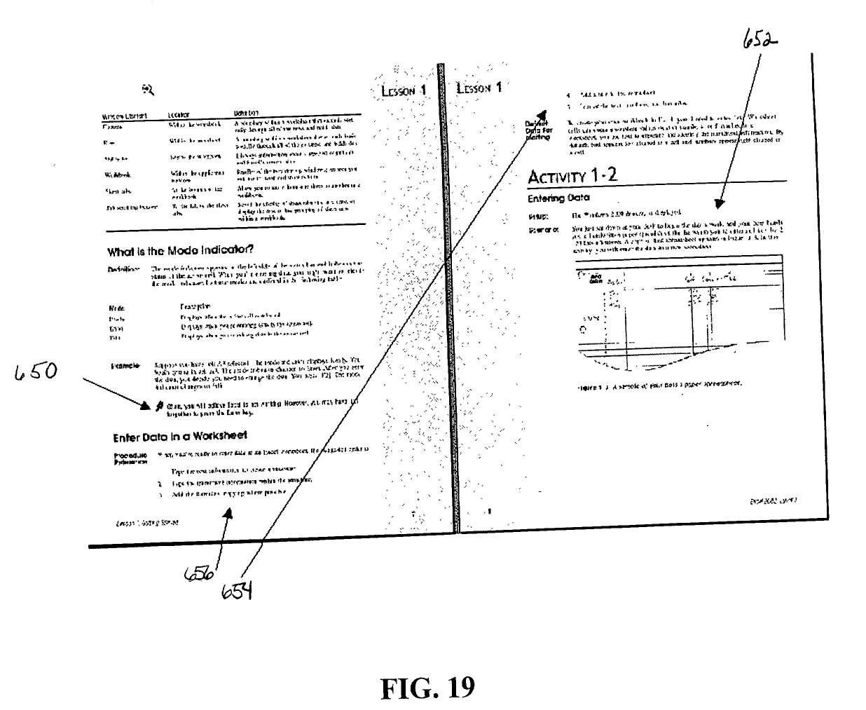

Referring to FIG. 19, a general procedure reference and scenario within an activity are illustrated. The general procedure reference gives the user the opportunity to see a generalized (i.e., not specific to the class example) reference of the required procedure steps useful for context as well as after class resource. Scenarios are consistently built into each activity, as may be required by the DTD, to build relevance and real world examples into the user's experience. Scenarios support user satisfaction and transfer of knowledge.

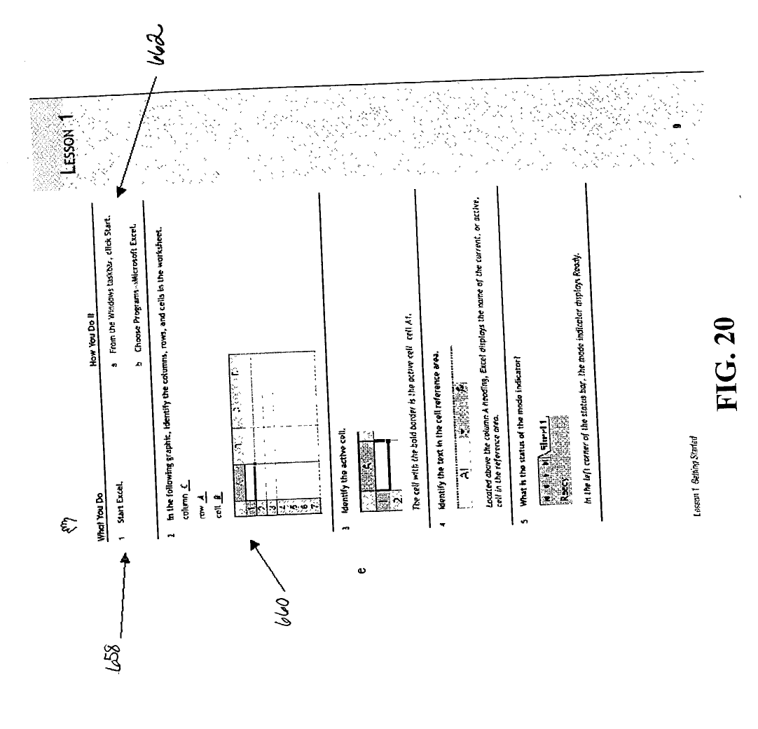

Referring to FIG. 20, a guided activity detail is illustrated. In an off-line guided activity, the scenario is followed by a two-column format. In the left side there is “what you do,” and in the right side “how you do it.” The left side gives the users an unguided step, and the right side gives them the associated guided steps. These levels of activity steps are appropriate to the user because it gives the user the appropriate level of confidence and satisfaction. User choice, confidence and satisfaction are applied as well as the ability to transfer learning.

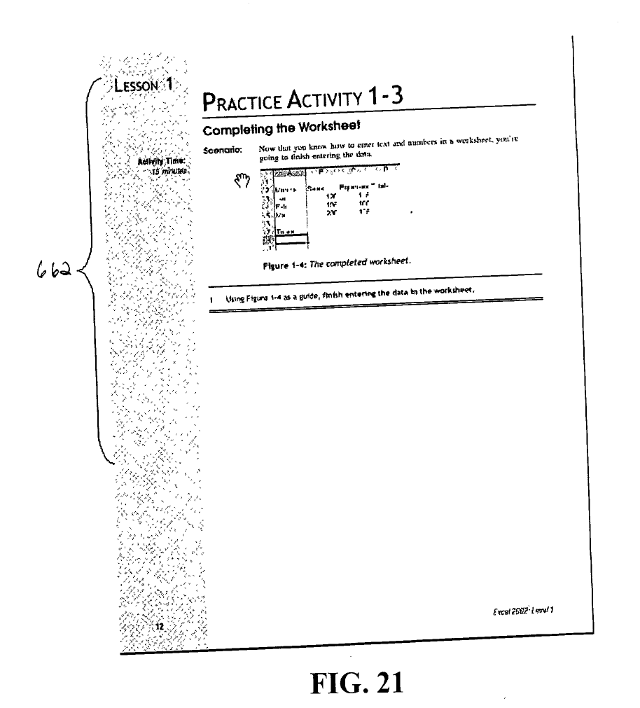

Referring to FIG. 21, a practice activity detail is illustrated. Practice activities are presented in a one column format and unguided steps are printed. A practice activity gives the user the opportunity to rehearse something they have already learned to a higher level of integration, application or complexity. It should be noted that while the discovery activities are presented in the same manner, the intent of the discovery activities is to allow the user to explore instead of rehearse.

The present invention provides training and documentation specific to each role in the design and development process, the interaction design and style guides, templates and behaviors, and the Design Type Definition (“DTD”), as described further herein. The DTD is the tool that ties the instructional design and the delivery technology together. The DTD defines the structure of the content as it is authored in an XML-based system, and determines what rules are associated with each piece of content. The rules that were determined in the development of the DTD were developed based on the principles of effective instruction described above and their related guidelines and criteria, and the existing SCORM, AICC and IMS standards, which are incorporated by reference herein in their entirety. The DTD ensures that the content developers develop instructional components based on the learning objectives they design in the course.

The DTD uses a content-performance matrix, internal implementation standards and customer research as its rules base. This way, the learning objective and the content type/performance level developed by the developer determines the structure of the instructional content (i.e., which components are required and available in the presentation components and in the activities), to ensure instructional effectiveness and consistency. The development and evaluation criteria exist exterior to the DTD, but the DTD supports the underlying content structure. In addition, the DTD is a learning object model where content can be customized for a specific job or organization and learning objects can be used across different instructional content. The DTD is updated based on internal business needs through a formal change control process.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A method for developing effective training materials, the method comprising:
developing a training course; and
ensuring the developing a training course observes at least one of a learning-centered principal, a results-oriented principal and an engagement principal.

2. The method as set forth in claim 1 wherein the developing a training course further comprises performing a plurality of course development phases.

3. The method as set forth in claim 2 wherein the performing a plurality of course development phases further comprises creating a detailed course design for guiding the course development phases.

4. The method as set forth in claim 3 further comprising evaluating the detailed course design to ensure compliance with the observing of the resultsoriented principle.

5. The method as set forth in claim 2 wherein the performing a plurality of course development phases further comprises developing lesson introductions and lesson activities for levels of the training course using a detailed course design.

6. The method as set forth in claim 5 wherein the performing a plurality of course development phases further comprises evaluating the lesson introductions and the lesson activities and wherein the evaluating the lesson introductions and the lesson activities provides at least a portion of the ensuring the developing a training course observes at least one of a learning-centered principal, a results-oriented principal and an engagement principal.

7. The method as set forth in claim 2 wherein the performing a plurality of course development phases further comprises revising the training course to ensure compliance with the observing of the at least one of the learningcentered principal, the results-oriented principal and the engagement principal.

8. The method as set forth in claim 2 further comprising revising the training course to ensure that the training course is technically, grammatically and stylistically correct.

9. The method as set forth in claim 1 further comprising presenting the developed training course by performing at least one of storing the developed training course in one or more computer-readable media, sending the developed training course to one or more client machines, and printing the developed training course onto a printing medium.

10. The method as set forth in claim I wherein the the developed training course is customized for at least one of an organization, a subject matter topic and a training course audience knowledge level.

11. A computer-readable medium having stored thereon instructions to develop effective training materials, which when executed by at least one processor, causes the processor to perform:
developing a training course; and
ensuring that the developed training course observes at least one of a learning-centered principal, a results-oriented principal and an engagement principal.

12. The medium as set forth in claim 11 wherein the developing a training course further comprises performing a plurality of course development phases to ensure compliance with the observing of the at least one of the learningcentered principal, the results-oriented principal and the engagement principal.

13. The medium as set forth in claim 12 wherein the performing a plurality of course development phases further comprises creating a detailed course design for guiding the course development phases.

14. The medium as set forth in claim 13 further comprising evaluating the detailed course design to ensure compliance with the observing of the resultsoriented principle.

15. The medium as set forth in claim 12 wherein the performing a plurality of course development phases further comprises developing lesson introductions and lesson activities for levels of the training course using a detailed course design.

16. The medium as set forth in claim 15 wherein the performing a plurality of course development phases further comprises evaluating the lesson introductions and the lesson activities to ensure compliance with the observing of the at least one of the learning-centered principal, the results-oriented principal and the engagement principal.

17. The medium as set forth in claim 12 wherein the performing a plurality of course development phases further comprises revising the training course to ensure compliance with the observing of the at least one of the learningcentered principal, the results-oriented principal and the engagement principal.

18. The medium as set forth in claim 12 further comprising revising the training course to ensure that the training course is technically, grammatically and stylistically correct.

19. The medium as set forth in claim 11 further comprising presenting the developed training course by performing at least one of storing the developed training course in one or more computer-readable media, sending the developed training course to one or more client machines, and printing the developed training course onto a printing medium.

20. The medium as set forth in claim 11 wherein the the developed training course is customized for at least one of an organization, a subject matter topic and a training course audience knowledge level.

21. A system for developing effective training materials, the system comprising:
a training course development system that develops a training course; and
a compliance system that ensures the developed training course observes at least one of a learning-centered principal, a results-oriented principal and an engagement principal.

22. The system as set forth in claim 21 wherein the compliance system further comprises one or more rules which ensure that training course content is organized within the training course in a manner that observes at least one of the learning-centered principal, the results-oriented principal and the engagement principal.

23. The system as set forth in claim 22 wherein the one or more rules form a data entry template.

24. The system as set forth in claim 22 wherein the compliance system further comprises an extensible markup language based document that is associated with a design type definition, the design type definition having the one or more rules.

25. The system as set forth in claim 21 wherein the compliance system has a plurality of course development phases which are to be completed by one or more course developers to ensure compliance with the observing of the at least one of the learning-centered principal, the results-oriented principal and the engagement principal.

26. The system as set forth in claim 25 further comprising a first version and a second version of the developed training course, the first version is presented on a first medium, the second version is presented on a second medium, the first and the second versions each observe at least one of the learning-centered principal, the results-oriented principal and the engagement principal.

27. The system as set forth in claim 26 wherein a collaboration between a content manager and a content developer during one or more of the course development phases ensures consistency between the first version and the second version.

28. The system as set forth in claim 21 further comprising a presentation system that presents the developed training course by performing at least one of storing the developed training course in one or more computerreadable media, sending the developed training course to one or more client machines, and printing the developed training course onto a printing medium.

29. The system as set forth in claim 21 wherein the training course development system customizes the developed training course for at least one of an organization, a subject matter topic and a training course audience knowledge level.
